(19) United States
(12) Patent Application Publication
(10) Pub. No.: US 2017/0113391 A1
(43) Pub. Date: Apr. 27, 2017

(54) PROCESS FOR PRODUCTION OF TUBULAR FILMS FOR PROTECTION OF MEDICAL DEVICES

(71) Applicant: Covestro LLC, Pittsburgh, PA (US)

(72) Inventors: Michael Lorenzo, McKees Rocks, PA (US); William Bodde, Belchertown, MA (US); Zhizhong Liu, Wilbraham, MA (US); Christopher Cooper, East Lyme, CT (US)

(21) Appl. No.: 15/315,423

(22) PCT Filed: Jun. 2, 2015
(86) PCT No.: PCT/US2015/033706

§ 371 Date: Dec. 1, 2016

Related U.S. Application Data
(60) Provisional application No. 62/006,462, filed on Jun. 2, 2014.

(51) Int. Cl. B29C 47/00; B29C 65/00; B29C 65/08

(52) U.S. Cl. CPC B29C 47/0064; B29C 47/0026; B29C 47/0021; B29C 47/0066; B29C 65/08; B29C 66/4312; B29K 2075/00

(57) ABSTRACT

The present invention provides a continuous process comprising, extruding two or more layers of a thermoplastic polyurethane film, welding the two or more layers of film at a first edge in a machine direction and simultaneously slitting the welded film with an angular section of an anvil blade and winding the welded, slitted thermoplastic polyurethane film onto a roller. The resultant thermoplastic polyurethane film in tubular form may find use in medical applications such as coverings on robotic arms used for performing surgery (by proxy).

### CROSS-REFERENCE TO RELATED APPLICATIONS

This application is a national stage application (under 35 U.S.C. §371) of PCT/US2015/033706, filed Jun. 2, 2015, which claims the benefit of U.S. Provisional Application No. 62/006,462, filed Jun. 2, 2014, both of which are incorporated herein by reference in their entirety.

The present invention relates in general to medical devices and more specifically to an in-line welding and slitting process for extruded thermoplastic polyurethane (TPU) films that are tubular and useful for the protection of medical devices, where high transparency, low blooming, and high slip (low surface coefficient of friction) are important to the application.

### FIELD OF THE INVENTION

### Background of the Invention

Robotic arms are used throughout industrial manufacturing processes, medical applications, and countless other environments where protecting the robotic arm from physical damage or environmental contamination is of high importance.

Thermoplastic polyurethane (TPU) films can be used in tube form as a protective sheath for medical devices to protect surgical instruments from physical damage (abrasion, scratch, tear, puncture etc.) as well as provide a barrier between the surgical instrument and patient. These thermoplastic polyurethane film sheaths can also be used for other industrial manufacturing applications where durability and flexibility are required

There are two main processing methods for thermoplastic polyurethane films, blown film extrusion and cast film extrusion. Because the geometry of the final part is tubular, blown film extrusion is the method of choice as the blown film method produces a natural tube. Blown film tubes can be produced for these applications, however, when small layflats are needed this approach can be cost prohibitive due to the low extrusion throughput when using a small circular die to make a small diameter “bubble” via the blown film process.

Ultrasonic welding employs an acoustic tool called a horn to transfer vibratory energy through a part to the joint area, where it is converted to heat through friction that melts the plastic. Ultrasonic welding can be used to join not only rigid thermoplastics, but fabrics and films as well. A number of workers in the art have explored ultrasonic welding.

For example, U.S. Pat. No. 5,435,863 issued to Frantz provides an ultrasonic processing method wherein during the processing time interval the motional amplitude of the resonating horn and thereby the power to the workpiece is reduced. The reduction in motional amplitude may be in response to a process condition such as a change in dimension of the workpiece or a sharp rise in the power curve, or it may be in response to the lapse of a predetermined time.

Grewell, in U.S. Pat. No. 5,855,706, describes an ultrasonic processing method wherein during the processing time interval the motional amplitude and engaging force of the resonating horn and thereby the power and engaging pressure to the workpiece is varied to improve weld strength and decrease weld cycle time. The variation in motional amplitude and engaging force may be in response to a process condition such as a change in dimensions of the workpiece, a sharp rise in the transducer power curve, or in response to the lapse of a predetermined time interval.

U.S. Pat. No. 6,712,832, issued to Shah details a low-pressure balloon, and method of forming the same by the steps of: preheating a thin film of thermoplastic polymeric material to a sufficient temperature; forming two halves of the balloon on the thin film by vacuum suction; isolating the two halves of the balloon; bonding the two halves together on their edges to form the low-pressure balloon by radio-frequency welding method; and inverting the low-pressure balloon from inside out to turn the rough bonded edge of the two halves into the interior side of the balloon,

Fujimaki et al., in U.S. Published Patent Application No. 2007/0052131, disclose a PET-based polyester packaging film said to be capable of weld-cut sealing and heat-shrinkage which is obtained by biaxially orienting a material prepared through block copolymerization of a PET/PETG/polyester elastomer with an epoxy resin and a catalyst. This film is said to eliminate the most serious weak points in physical properties of conventional PET films, and to be useful for packaging of books, bottlesets, food containers, etc., for general packaging, packaging of industrial materials, and the like, and is further said to be useful in the field of packing and packaging of daily commodities, civil engineering and construction members, electric and electronic members, and automobile vehicle members, etc. Moreover, this film is said to be able to be produced through effective use of the huge amount of recycled PET bottles and inexpensive PET for fiber as a prepolymer, and thus is also highly beneficial socially. Still further, even if incinerated after use, this film is said to produce a combustion heat value lower than that of a polyethylene or polypropylene. Thus, the film of Fujimaki et al., is claimed to barely damage incinerators or the like, and emit no toxic gases.

DE3342619 in the name of Walter et al., describes an ultrasonic welding process as well as a machine for carrying out the process, with which process a thermoplastic can be quickly, reliably and homogeneously welded. In particular, relatively long continuous and homogeneous weld seams can be produced, for example for welding bumpers and spoilers in motor vehicles.

Thomsen et al, in EP0475782 disclose a process for welding sheet material comprising a thermoplastic polymer. The process comprises overlapping edges of the sheet material to form a lap joint, supporting the lap joint on an anvil, and welding the lap joint by contacting and traversing the lap joint with an ultrasonic welding horn. The welding horn is oscillated at a frequency of between about 30 kHz and about 45 kHz while contacting and traversing the lap joint with the welding horn. The welding horn is preferably highly thermally conductive.

A need continues to exist in the art for continuous processes of producing tubular sheaths capable of use as coverings on robotic arms.

### SUMMARY OF THE INVENTION

Accordingly, the present invention provides a continuous process comprising, extruding two or more layers of a thermoplastic polyurethane film, welding the two or more layers of film at a first edge in a machine direction and simultaneously slitting the welded film with an angular section of an anvil blade and winding the welded, slitted thermoplastic polyurethane film onto a roller. The resultant thermoplastic polyurethane film in tubular form may find use in medical applications such as coverings on robotic arms used for performing surgery (by proxy).

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 a diagram of a blown film extrusion line including an ultrasonic welding unit illustrating the continuous process of the invention; and

FIG. 2 is a photograph showing a 4× image of small angle anvil wheel thermoplastic polyurethane film weld and cut.

### DETAILED DESCRIPTION OF THE INVENTION

Various embodiments are described and illustrated in this specification to provide an overall understanding of the structure, function, operation, use, and manufacture of the disclosed invention(s). The various embodiments described and illustrated herein are non-limiting and non-exhaustive. Thus, the invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other material identified herein is incorporated herein by reference in its entirety unless otherwise indicated, but only to the extent that the incorporated material does not conflict with existing definitions, statements, or other disclosure material expressly set forth herein. As such, and to the extent necessary, the express disclosure as set forth herein supersedes any conflicting material incorporated by reference. Any material, or portion thereof, that is said to be incorporated by reference herein, but which conflicts with a definition, statement, or other disclosure material set forth herein, is only incorporated to the extent that no conflict arises between the incorporated material and the present disclosure. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

In various embodiments, the present invention provides continuous processes comprising: extruding two or more layers of a thermoplastic polyurethane film; welding the two or more layers of film at a first edge in a machine direction and simultaneously slitting the welded film with an angular section of an anvil blade; and winding the welded, slitted thermoplastic polyurethane film onto a roller. The resultant thermoplastic polyurethane film in tubular form may find use in a variety of applications, including medical applications such as coverings on robotic arms used for performing surgery (by proxy).

In various embodiments, aliphatic thermoplastic polyurethanes are particularly preferred, such as those prepared according to U.S. Pat. No. 6,518,389, the entire contents of which is incorporated herein by reference.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). In some embodiments, catalysts may be added to the reaction to speed up the reaction of the components.

In various embodiments, the relative amounts of the components may be varied over a wide range of molar ratios to adjust the properties of the resultant materials, Molar ratios of polyols to chain extenders from 1:1 to 1:12 have been reported. These result in products with hardness values ranging from 80 Shore A to 85 Shore D.

In certain embodiments, the thermoplastic polyurethanes are produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of suitable polyols include difunctional polyether polyols, polyester polyols, and polycarbonate polyols. Small amounts of trifunctional polyols may be used, yet care must be taken to ensure that the thermoplasticity of the thermoplastic polyurethane remains substantially unaffected.

In certain embodiments, suitable polyols are polyester polyols including those which are prepared by polymerizing ε-caprolactone using an initiator such as ethylene glycol, ethanolamine and the like. Further suitable examples are prepared by esterification of polycarboxylic acids. The polycarboxylic acids may be aliphatic, cycloaliphatic, aromatic and/or heterocyclic and they may be substituted, e.g., by halogen atoms, and/or unsaturated. The following may be mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate.

In certain embodiments, suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes used in producing the films useful in the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic diols containing 2 to 14 carbon atoms, such as ethanediol, 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(13-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 26-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. %, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for instance, from Bayer MaterialScience under the TEXIN name, from BASF under the ELASTOLLAN name and from Lubrizol under the trade names of ESTANE and PELLETHANE.

Ultrasonic welding equipment (available from various commercial suppliers such as Branson Ultrasonics Corp.) may be used in some embodiments to weld two or more layers of thermoplastic polyurethane (TPU) film at a thickness of from 25.4 μm-508 μm (1-20 mil) continuously in the machine direction. Ultrasonic welding uses ultrasonic frequency vibration waves to excite the substrate material. The vibration causes frictional heating which raises the temperature of the material above the melting point. Once the material is in the melt phase, a bond is formed and allowed to cool to below the melting point as the weld area is moved downstream along the web path. The resulting weld may be referred to as a “butt weld” of the “near field” variety.

In some embodiments, simultaneously with the same welding action, the film may be slit by an angular section of an anvil blade as the horn strikes the film at an ultrasonic frequency. In various embodiments, ultrasonic welding units may be placed in the web path of an extrusion line creating a continuous extrusion/welding/slitting/winding process. In certain embodiments, the resulting weld is preferably 1 mm wide. In certain embodiments, the weld strength will vary based on such factors as the chemistry, durometer, density, elastic modulus, and melt temperature of the thermoplastic polyurethane; the extruder line speed; the film thickness; the tensile testing parameters; and the ultrasonic welding parameters.

In various embodiments, the weld strength was measured by an adaptation of ASTM D-882. Weld strength for a weld between two 101.6 μm (4 mil) thermoplastic aromatic polyurethane film layers based on polyester TPU (92 Shore A, commercially available from manufacturers Bayer MaterialScience, BASF, and Lubrizol) resulted in a mean 180° peel strength of 1,850 N/cm²(2,685.4 psi) as determined by ASTM D903. Similar welding strength can also be achieved for aromatic polyether TPU films.

Initial welding tests were done using BRANSON FS-90 model which operated at 20 kHz and used 85% amplitude with thermoplastic polyurethane film. This welds and slits the web simultaneously. There are different types of anvil wheel designs. Some anvil wheels weld only; they do not cut, whereas other anvil wheels both weld and cut.

As those skilled in the art will appreciate, weld strength increases with the angle of the tip of the anvil wheel and the slitting ability of the system decreases with increasing angle of the anvil wheel. An anvil wheel that has a wide band in the middle of the wheel will produce a weld, but is not sharp enough to both weld and slit the incoming film. Other anvil wheels which are capable of both cutting and sealing may be referred to as “cut and seal” anvil wheels. Optimal conditions for practice of certain embodiments of the present invention are a balance between weld strength and slitting ability. A 90° anvil wheel has shown the best balance of weld strength and slitting ability for thermoplastic polyurethane films. In certain embodiments, it is possible to drive the anvil wheel at some speed which is greater than the line speed to improve the welding/slitting process.

In various embodiments, the thermoplastic polyurethane films may be heat sealed using a hot drum. The drum applies heat to weld the layers of film together and a separate slitter cuts the film in the next step.

In some embodiments, welded tubes may be continuously wound onto multiple cores on a winder shaft. In various embodiments, the tubes may have a first edge created by an ultrasonic weld and a second edge created by the natural edge resulting from a blown film bubble collapsing from a circular geometry to an ellipse. In certain embodiments, both edges may be created from ultrasonic or heat welding, thus providing a more uniform appearance.

The present disclosure now turns to a description of an embodiment of the inventive blown film extrusion process with integrated cut-and-seal ultrasonic welder. Blown film extrusion uses an extruder which is preferably 30:1 length to barrel diameter ratio for TPU. Blown film dies have a circular geometry and can have various diameters for various applications. The present inventors have observed that the larger the diameter, the higher the extruder output. The final diameter of the film is determined by the blow up ratio which is a function of the viscoelastic properties of the polymer and the extrusion conditions. The final width of the film in roll form will always be larger than the die diameter due to blow up of the film and the geometry of collapsing the blown film bubble. For example, for a die with a 35.6 cm (14 inch) diameter, high output may be achieved at a final layflat of 102 cm (40 inches), but if a 50.8 cm (20 inch) layflat is needed this could be an inefficient process (due to low line speeds and screw speeds needed).

To produce small layflat tubes with a high efficiency, it is possible to extrude a high throughput layflat at least two times of targeted layflat width and then weld and slit the web to create multiple sealed tubes in a continuous process. A continuous welding process is more efficient than a batch welding process due to the higher throughput and therefore less time is needed to weld the same amount of material. The continuous in-line process of the present invention also removes a step from taking a blown film tube material and welding it in a secondary operation.

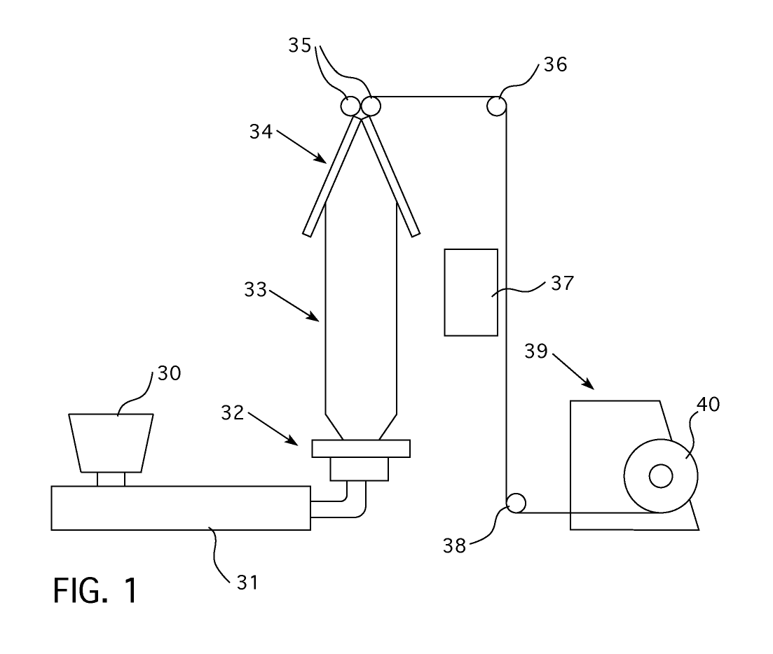

FIG. 1 is a diagram of a blown film extrusion line, including an ultrasonic welding unit illustrating the continuous process of certain embodiments of the invention. Hopper 30 contains aromatic thermoplastic polyurethane which is fed into extruder 31 and extruded through die 32 to produce film bubble 33 which is collapsed by collapsing frame 34. The collapsed film travels on nip rollers 35 over a first idler roll 36 and through ultrasonic welder/cutter unit 37. The welded/slit film passes over a second idler roll 38 and is continuously wound by winder 39 onto a roll 40.

An ultrasonic welding “cut and seal” unit can also be used in various embodiments of the inventive continuous process. In an ultrasonic welding unit, a film is fed inbound from a blown film tower to one or more anvil wheels and horn for simultaneous cutting and welding. The welded/slit film may be trimmed en route to the winder.

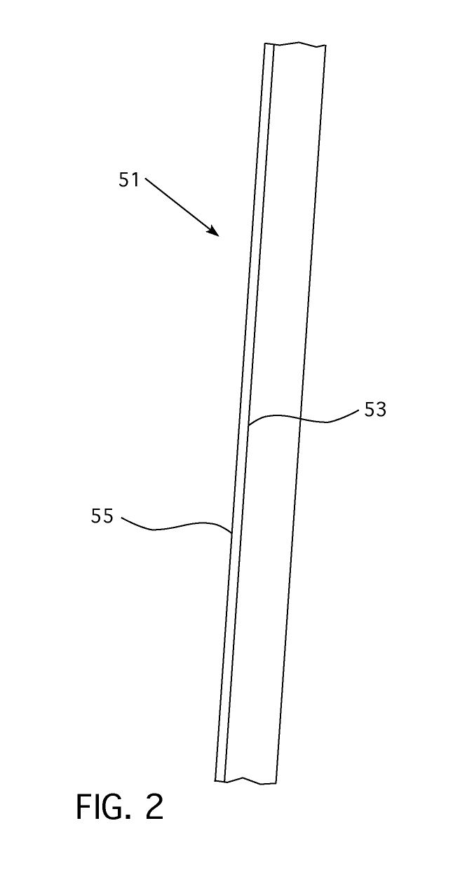

FIG. 2 is a photograph showing a 4× image of small angle anvil wheel thermoplastic polyurethane film (2×4 mil layers of film) weld and cut. Seal 51 is made by the small angle anvil wheel. the edge of the cut is shown at 53 and the edge of the weld at 55. The region between the edge of the weld and the start of the cut is ˜200 μm.

Thermoplastic polyurethane films in tube form may find use in medical applications such as coverings on robotic arms used for performing surgery (by proxy). Thermoplastic polyurethane is a material well-suited to demanding medical applications because of its relatively inert nature, high mechanical strength and superior abrasion resistance, when compared with other flexible polymer materials.

Robotic arms are used throughout industrial manufacturing processes, medical applications, and countless other environments where protecting the robotic arm from physical damage or environmental contamination is of high importance. High transparency, low blooming, high slip (low surface coefficient of friction) thermoplastic polyurethane thin tubing is an excellent choice for fabricating a protective sheath for these demanding applications. Thermoplastic polyurethane provides high elasticity, strength, elongation, and flexibility (60-95 Shore A) compared to other flexible materials and it does not contain any potentially unsafe plasticizing agents. The inherent wear and abrasion resistance of

thermoplastic polyurethane makes it an ideal choice for use as a protective sheath. The high transparency, low blooming and high slip formulation ensures that the material exhibits high clarity through the duration of its lifecycle and does not become hazy over time, while still allowing enough slip of the material to allow the operator to install the sheath over the arm with ease.

Thermoplastic polyurethane tubes were tested for weldability and optical properties, including an aromatic, polyether TPU formulation PT75D (Ex. 1) and an aromatic, polyester TPU formulation PS80C (Ex. 2). Both formulations were ˜90 Shore A durometer, film coefficients of friction (COF) were lower than 0.5, film light transmission were higher than 90%. PT75D film (Ex. 1) contained less than 2 wt. % amorphous silica particle (100-200 μm particle size) and less than 0.1% lube. Coefficient of friction of 101.6 μm (4 mil) PT75D film was measured at 0.33. PS80C film contained less than 1 wt. % amorphous silica particle (100-200 μm particle size), less than 0.2 wt. % wax and less than 0.1 wt. % lube (lube and wax based on fatty acid amides, such as GLYCOLUBE and ACRAVVAX ((N,N′ ethylene bisstearamide)). Coefficient of friction of 101.6 μm (4 mil) PS80C film was measured at 0.21. The results of mechanical testing are provided in Table I.

TABLE I

| | 180° Weld Peel | Tensile | | |
|---|---|---|---|---|
| | Strength for “Cut | Strength | % of Tensile | TPU |
| Ex. | and Seal” weld | of film | Strength | Hardness |
| 1 | 1,650 N/cm² | 8,620 N/cm² | ~19% | 92 Shore A |
| | (2,388.5 psi) | (12,500 psi) | | |
| 2 | 1,850 N/cm² | 7,790 N/cm² | ~24% | 92 Shore A |
| | (2,685.4 psi) | (11,300 psi) | | |

180° Peel strength tests on thermoplastic polyurethane films at 101.6 μm (4 mil) exhibited more than enough strength to meet the protective sheath requirements. Specimens will typically fail in the weld region, as opposed to the base material. Testing was performed at a cross head speed of 2.54 cm (1 inch) per minute, with a grip distance of 2.54 cm (1 inch).

Blooming tests were conducted on the formulations of Ex, 1 (PT75D) and Ex. 2 (PS80C). See Table H for results. Blooming tests were also conducted on a control sample which bloomed significantly over time due to the relatively high level of lube (0.3 wt. %) that was added to the formulation. Coefficient of friction of this control film was measured at 0.10. Wax and lube were added to the thermoplastic polyurethane to improve slip properties of the film. Wax and lube will slowly migrate to the surface of the film causing a surface haze which is undesirable in the finished part. The thermoplastic polyurethane formulations used for this application use combination of silica particle additive or diatomaceous earth additive and low level of wax (<0.5 wt. %) and lube (<0.15 wt. %) to provide high slipping while minimizing blooming of wax and lube and give a stable, clear surface which will not become significantly hazier or “bloom” significantly over time. Table III shows an example of TPU formulation, P38-B, having less than 1% diatomaceous earth additive, less than 0.3% wax and less than 0.1% lube. Coefficient of friction of 101.6 μm (4 mil) PS8-B film was measured at 0.20.

The amount of “blooming” can be quantified by testing the percent light transmission and percent haze of the material at incremental time intervals during oven aging. Blooming of lube or wax usually causes decreasing of overall film light transmission and a significant increase in film haziness. The Total Light Transmission (TLT) and Haze both determined by ASTM D1003 are provided in Tables II and III.

TABLE II

| | | |
|---|---|---|
| Control | PT75D | PS80C |

| Time | TLT | Haze | TLT | Haze | TLT | Haze |
|---|---|---|---|---|---|---|
| Start | 92.9 | 20.45 | 91.4 | 8.81 | 92.15 | 8.7 |
| 2 Weeks | 93.15 | 57.7 | 92.1 | 8.86 | 92.25 | 9.86 |
| 4 Weeks | 92.21 | 72.1 | 92.25 | 11.25 | 91.9 | 11.4 |
| 6 Weeks | 91.3 | 72.2 | 92.6 | 13.2 | 92.0 | 11.7 |
| 8 Weeks | 90.4 | 72.25 | 93.0 | 15.2 | 92.0 | 12.2 |
| 3 Months | 86.9 | 79.5 | 91.9 | 15.1 | 92.3 | 12.4 |
| 4 Months | 93.2 | 79.1 | 92.6 | 16.3 | 92.0 | 13.0 |

TABLE III

| | |
|---|---|
| PS8-B | Control |

| Time | TLT | Haze | TLT | Haze |
|---|---|---|---|---|
| Start | 91.9 | 26.5 | 92.9 | 20.45 |
| 2 Weeks | 91.8 | 26.8 | 93.15 | 57.7 |
| 4 Weeks | 92.3 | 28.7 | 92.21 | 72.1 |
| 6 Weeks | 92.3 | 28.7 | 91.3 | 72.2 |
| 8 Weeks | 92.7 | 28.5 | 90.4 | 72.25 |

The foregoing description of the present invention is offered for the purpose of illustration and not limitation. It will be apparent to those skilled in the art that the embodiments described herein may be modified or revised in various ways without departing from the spirit and scope of the invention. The scope of the invention is to be measured by the appended claims.

Various aspects of the subject matter described herein are set out in the following numbered clauses:

1. A continuous process comprising: extruding two or more layers of a thermoplastic polyurethane film; welding the two or more layers of film at a first edge in a machine direction and simultaneously slitting the welded film with an angular section of an anvil blade; and winding the welded, slitted thermoplastic polyurethane film onto a roller.

2. The continuous process according to clause 1, wherein the welding comprises ultrasonic welding.

3. The continuous process according to clause 1, wherein the welding comprises heat sealing with a hot drum.

4. The continuous process according to any one of clauses 1 to 3, wherein the thermoplastic polyurethane film has a thickness of from 25.4 μm-508 μm (1-20 mil).

5. The continuous process according to any one of clauses 1 to 4 further including welding the two or more layers of film at a second edge.

6. The continuous process according to clause 5, wherein the welding at the second edge comprises ultrasonic welding.

7. The continuous process according to clause 5, wherein the welding at the second edge comprises heat sealing with a hot drum.

8. A transparent, low blooming, and low coefficient of friction thermoplastic polyurethane film prepared according to any of the continuous welding processes of clauses 1 through 7, wherein the thermoplastic polyurethane film has coefficient of friction lower than 0.5, light transmission higher than 85%, haze lower than 35%, haze increases less than 10% and light transmission decreases less than 5% over 8 weeks of aging under 40° C. and 90% humidity.

9. The thermoplastic polyurethane film according to clause 8 which comprises an aromatic polyester thermoplastic polyurethane or an aromatic polyether thermoplastic polyurethane, less than 2 wt. % amorphous silica particle additive, and less than 0.2 wt. % wax and/or less than 0.1 wt. % lube.

10. The thermoplastic polyurethane film according to clause 8 which comprises an aromatic polyester thermoplastic polyurethane or an aromatic polyether thermoplastic polyurethane, less than 1 wt. % diatomaceous earth additive, and less than 0.3 wt. % wax and/or less than 0.1 wt. % lube.

What is claimed is:

1. A continuous process comprising:
extruding two or more layers of a thermoplastic polyurethane film;
welding the two or more layers of film at a first edge in a machine direction and simultaneously slitting the welded film with an angular section of an anvil blade; and
winding the welded, slitted thermoplastic polyurethane film onto a roller.

2. The continuous process according to claim 1, wherein the welding comprises ultrasonic welding.

3. The continuous process according to claim 1, wherein the welding comprises heat sealing with a hot drum.

4. The continuous process according to claim 1, wherein the thermoplastic polyurethane film has a thickness of from about 25.4 μm-508 μm (1-20 mil).

5. The continuous process according to claim 1 further including welding the two or more layers of film at a second edge.

6. The continuous process according to claim 5, wherein the welding at the second edge comprises ultrasonic welding.

7. The continuous process according to claim 5, wherein the welding at the second edge comprises heat sealing with a hot drum.

8. A transparent, low blooming, and low coefficient of friction thermoplastic polyurethane prepared by the continuous welding process of claim 1, wherein the resultant thermoplastic polyurethane film has coefficient of friction lower than about 0.5, light transmission higher than about 85%, haze lower than about 35%, haze increases less than about 10% and light transmission decreases less than about 5% over 8 weeks of aging under 40° C. and 90% humidity,

9. The thermoplastic polyurethane film according to claim 8, wherein said thermoplastic polyurethane comprises an aromatic polyester thermoplastic polyurethane or an aromatic polyether thermoplastic polyurethane, less than about 2 wt. % amorphous silica particle additive, and less than about 0.2 wt. % wax and/or less than about 0.1 wt. % lube.

10. The thermoplastic polyurethane film according to claim 8, wherein said thermoplastic polyurethane comprises an aromatic polyester thermoplastic polyurethane or an aromatic polyether thermoplastic polyurethane less than about 1 wt. % diatomaceous earth additive, and less than about 0.3 wt. % wax and/or less than about 0.1 wt. % lube.
